(19) United States
(12) Patent Application Publication
(10) Pub. No.: US 2026/0065584 A1
(43) Pub. Date: Mar. 5, 2026

(54) SYSTEM AND METHOD FOR RENDERING A REFLECTION FOR A VIRTUAL OBJECT IN AN ELECTRONIC DEVICE

(71) Applicant: Samsung Electronics Co., Ltd., Suwon-si (KR)

(72) Inventors: K Vikas GOWDA, Bangalore (IN); Ankit DHIMAN, Bangalore (IN); Shubham MONGA, Bangalore (IN); Basavaraja Shanthappa VANDROTTI, Bangalore (IN); Lokesh Rayasandra BOREGOWDA, Bangalore (IN); Kihwan KIM, Suwon-si (KR)

(21) Appl. No.: 19/301,277

(22) Filed: Aug. 15, 2025

Related U.S. Application Data
(63) Continuation of application No. PCT/KR2025/012228, filed on Aug. 12, 2025.

(30) Foreign Application Priority Data
Aug. 27, 2024 (IN) 202441064557

(51) Int. Cl. G06T 15/50; G06T 15/06; G06T 19/00

(52) U.S. Cl. CPC G06T 15/506; G06T 15/06; G06T 19/006

(57) ABSTRACT

A method for rendering a reflection for a virtual object in an electronic device is provided. The method includes obtaining one or more red, green, and blue (RGB) frames and a depth-map associated with an augmented reality (AR) scene visualized in the electronic device for a user, determining one or more reflective surfaces in the AR scene based on the obtained RGB frames and the depth-map, identifying a type of the determined one or more reflective surfaces in the AR scene, generating a reflection map for the determined one or more reflective surfaces based on a placement of the virtual object, the identified type of the determined one or more reflective surfaces, and applying the generated reflection map on the determined one or more reflective surfaces to render the reflection for the virtual object in the electronic device.

### CROSS-REFERENCE TO RELATED APPLICATION(S)

This application is a continuation application, claiming priority under 35 U.S.C. § 365(c), of an International application No. PCT/KR2025/012228, filed on Aug. 12, 2025, which is based on and claims the benefit of an Indian Complete patent application number 202441064557, filed on Aug. 27, 2024, in the Indian Patent Office, the disclosure of which is incorporated by reference herein in its entirety.

### FIELD OF THE INVENTION

The disclosure relates to the field of augmented reality/mixed reality (AR/MR). More particularly, the disclosure relates to a system and a method for rendering a reflection for a virtual object in an electronic device.

### BACKGROUND

More and more services and additional functions are being provided via an electronic devices. To meet the needs of various users and raise use efficiency of electronic devices, communication service carriers or device manufacturers are jumping into competitions to develop electronic devices with differentiated and diversified functionalities. Accordingly, various functions that are provided through the electronic devices are evolving more and more.

The above information is presented as background information only to assist with an understanding of the disclosure. No determination has been made, and no assertion is made, as to whether any of the above might be applicable as prior art with regard to the disclosure.

### SUMMARY

Mixed Reality/Augmented Reality (MR/AR) are emerging technologies that blur the lines between the physical and the digital world and are currently being used in various fields, for example, the medical field, the gaming field, etc. In an AR space, virtual objects and/or annotations, such as a piece of information are overlaid onto the physical environment, altering the perception of a user. In addition, in the MR space, both the physical environment and the digital world are combined in a shared environment, where the best of virtual reality (VR) and AR are blended to create an interactive experience for the user. Further, as the virtual objects and the information are overlaid onto the physical environment, a more immersive and engaging experience is created for the user. When the virtual objects are overlaid onto the physical environment, a photo-realistic effect, for example, shadows, specular reflections, etc., caused by the physical environment on the virtual objects is rendered into the AR/MR space, through various means, for example, graphics algorithm.

FIGS. 1A, 1B, and 1C illustrate scenarios depicting challenges faced while inserting a virtual object in Augmented Reality/Mixed Reality space according to the related art.

Referring to FIG. 1A, a setting 100 of a reflection of a glass 104, of the physical environment, is visible on a virtual crystal ball 102.

However, the virtual objects overlaid onto the physical environment in the AR/MR space have certain limitations, that, when the virtual objects, having a 3-dimensional (3D) structure, are overlaid on the physical environment, the effect caused by the virtual objects on a reflective surface of the physical environment are not visible to the user. The effect is not visible due to the lack of accurate positioning of the virtual objects within the reflective surface of the physical environment. Further, the effect caused by the virtual objects is only rendered to a known virtual surface in the AR/MR space. The rendered virtual objects in the physical environment look artificial and lack photo-realism in the AR/MR space. This affects the seamless integration of the virtual objects in the physical environment, thereby compromising the experience of the user while accessing the AR/VR space.

Additionally, in some scenarios, if the virtual object 102 is directly placed in front of the reflective surface of the physical environment, then this leads to incorrect reflection of the virtual object 102 as shown in FIGS. 1B and 1C.

Aspects of the disclosure are to address at least the above-mentioned problems and/or disadvantages and to provide at least the advantages described below. Accordingly, an aspect of the disclosure is to provide a system and a method for rendering a reflection for a virtual object in an electronic device.

Additional aspects will be set forth in part in the description which follows and, in part, will be apparent from the description, or may be learned by practice of the presented embodiments.

In accordance with an aspect of the disclosure, a system for rendering a reflection for a virtual object in an electronic device is provided. The system includes memory, comprising one or more storage media, storing instructions, and at least one processor communicatively coupled with the memory, wherein the instructions, when executed by the at least one processor individually or collectively, cause the electronic device to obtain one or more red, green, and blue (RGB) frames and a depth-map associated with an augmented reality (AR) scene visualized in the electronic device for a user, determine one or more reflective surfaces in the AR scene, based on the obtained RGB frames and the depth-map, identify a type of the determined one or more reflective surfaces in the AR scene, generate a reflection map for the determined one or more reflective surfaces based on a placement (e.g., location) of the virtual object, and the identified type of the determined one or more reflective surfaces, and apply the generated reflection map on the determined one or more reflective surfaces to render the reflection for the virtual object in the electronic device.

In accordance with another aspect of the disclosure, a method for rendering a reflection for a virtual object in an electronic device is provided. The method includes obtaining one or more red, green, and blue (RGB) frames and a depth-map associated with an augmented reality (AR) scene visualized in the electronic device for a user, determining one or more reflective surfaces in the AR scene, based on the obtained RGB frames and the depth-map, identifying a type of the determined one or more reflective surfaces in the AR scene, generating a reflection map for the determined one or more reflective surfaces based on a placement of the virtual object, and the identified type of the determined one or more reflective surfaces, and applying the generated reflection map on the determined one or more reflective surfaces to render the reflection for the virtual object in the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations is provided. The operations include obtaining one or more red, green, and blue (RGB) frames and a depth-map associated with an augmented reality (AR) scene visualized in the electronic device for a user, determining one or more reflective surfaces in the AR scene, based on the obtained RGB frames and the depth-map, identifying a type of the determined one or more reflective surfaces in the AR scene, generating a reflection map for the determined one or more reflective surfaces based on a placement of a virtual object, and the identified type of the determined one or more reflective surfaces, and applying the generated reflection map on the determined one or more reflective surfaces to render the reflection for the virtual object in the electronic device.

Other aspects, advantages, and salient features of the disclosure will become apparent to those skilled in the art from the following detailed description, which, taken in conjunction with the annexed drawings, discloses various embodiments of the disclosure.

In accordance with another aspect of the disclosure, an electronic device, comprising, memory storing instructions, and at least one processor communicatively coupled with the memory, wherein the instructions, when executed by the at least one processor individually or collectively, cause the electronic device to, while an augmented reality (AR) is provided through electronic device, obtain at least one image frame and depth information related to the AR, wherein the at least one image frame includes a virtual object provided through the AR, based on the at least one image frame and the depth information, determine whether at least one reflective surface is included in the at least one image frame related to the AR, based on the determination that the at least one reflective surface is in the at least one image frame, identify a type of the at least one reflective surface in the at least one image frame, based on a specified location of the virtual object provided through the AR and the type of the at least one reflective surface, generate a reflection map including information on a reflection of the virtual object located on the specified location, and apply, for rendering the reflection of the virtual object through the electronic device, the reflection map on the at least one reflective surface.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, and 1C illustrate scenarios depicting challenges faced while inserting a virtual object in Augmented Reality/Mixed Reality space according to the related art;

FIG. 2 illustrates an environment of a system communicably coupled with a device, according to an embodiment of the disclosure;

FIG. 3 illustrates a block diagram of a system, according to an embodiment of the disclosure;

FIG. 4A illustrates a block diagram of an operation performed by a system, according to an embodiment of the disclosure;

FIG. 4B illustrates a flowchart of an operation performed by a system, according to an embodiment of the disclosure;

FIG. 5 illustrates a block diagram depicting a formation of a 3D mesh by a system, according to an embodiment of the disclosure;

FIG. 6 illustrates a block diagram depicting a formation of a feature map by a system, according to an embodiment of the disclosure;

FIG. 7A illustrates a block diagram depicting a formation of a plurality of two-dimensional (2D) points by a system, according to an embodiment of the disclosure;

FIG. 7B illustrates a block diagram depicting a determination of one or more reflective surfaces by a system, according to an embodiment of the disclosure;

FIG. 8 illustrates a block diagram depicting an identification of a type of determined one or more reflective surfaces, according to an embodiment of the disclosure;

FIG. 9A illustrates an estimation of a surface normal by a system, according to an embodiment of the disclosure;

FIGS. 9B and 9C illustrate estimations of a viewing frustum in a system, according to various embodiments of the disclosure;

FIG. 9D illustrates a ray projected by a system, according to an embodiment of the disclosure;

FIG. 9E illustrates an intersection of a projected ray and a virtual object, according to an embodiment of the disclosure;

FIG. 9F illustrates an attenuation of a color in a system, according to an embodiment of the disclosure;

FIGS. 10A and 10B illustrate block diagrams depicting an implementation of a system, without departing from the scope according to various embodiments of the disclosure;

FIGS. 11A and 11B illustrate examples of an operation performed by a system, according to various embodiments of the disclosure; and

FIG. 12 is a block diagram illustrating rendering reflection of a virtual object photo-realistically using semantic cues from the estimated reflection map and depth cues from the input depth modality/available 3D volume representation.

FIG. 13 illustrates a method performed by a system to render reflection for a virtual object in a device, according to an embodiment of the disclosure.

FIG. 14 is a block diagram illustrating an electronic device in a network environment according to various embodiments.

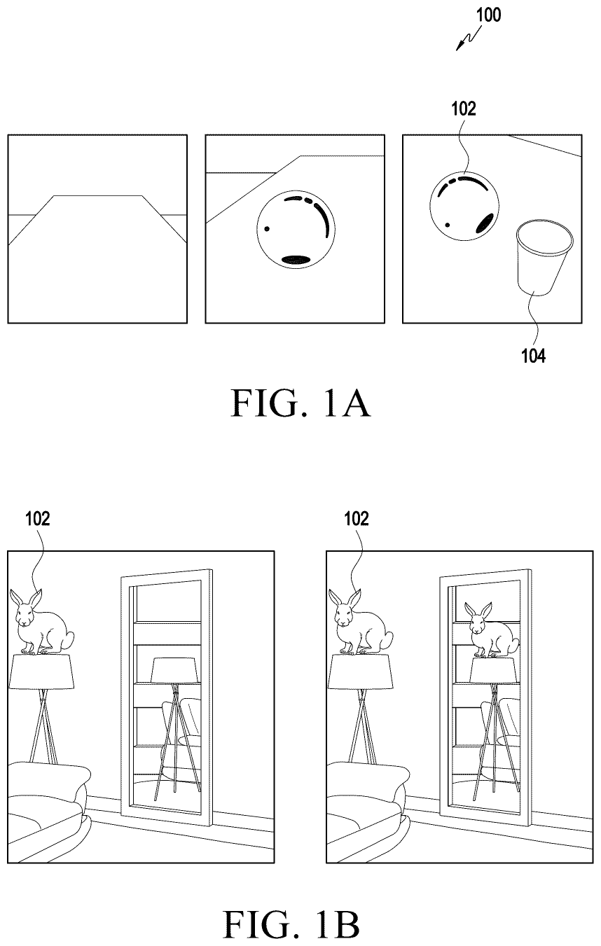

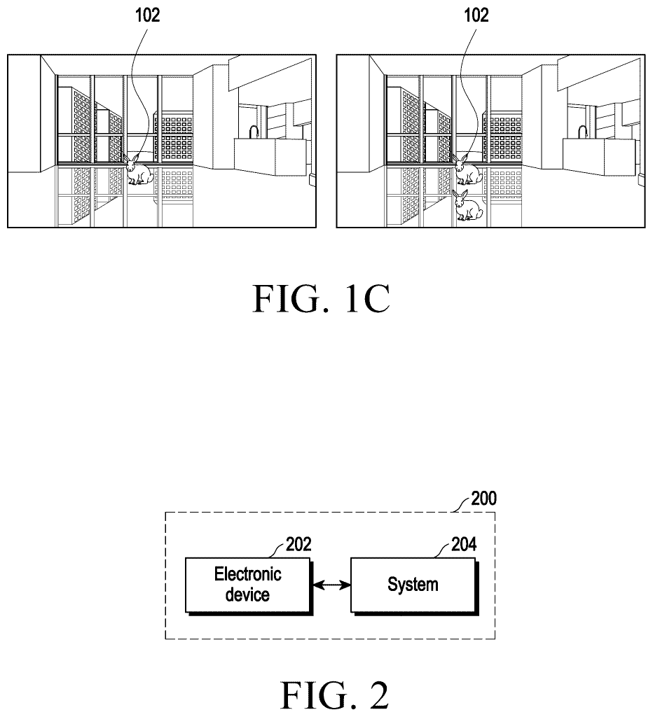

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the disclosure in any way.

In another example, any terms used herein, such as “includes,” “comprises,” “has,” “consists,” and similar grammatical variants do not specify an exact limitation or restriction, and certainly do not exclude the possible addition of a plurality of features or elements, unless otherwise stated. Such terms must not be taken to exclude the possible removal of the plurality of the listed features and elements, unless otherwise stated, for example, by using the limiting language including, but not limited to, “must comprise” or “needs to include.”

Whether or not a certain feature or element was limited to being used only once, it may still be referred to as “plurality of features” or “plurality of elements” or “at least one feature” or “at least one element.” The use of the terms “plurality of” or “at least one” feature or element do not preclude there being none of that feature or element, unless otherwise specified by limiting language including, but not limited to, “there needs to be plurality of . . . ” or “plurality of elements is required.”

Unless otherwise defined, all terms and especially any technical and/or scientific terms, used herein may be taken to have the same meaning as commonly understood by a person ordinarily skilled in the art.

Reference is made herein to some “embodiments.” It should be understood that an embodiment is an example of a possible implementation of any features and/or elements of the disclosure. Some embodiments have been described for the purpose of explaining plurality of the potential ways in which the specific features and/or elements of the proposed disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, plurality of particular features and/or elements described in connection with plurality of embodiments may be found in one embodiment, or may be found in more than one embodiment, or may be found in all embodiments, or may be found in no embodiments. Although plurality of features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The disclosure discloses a system and method for rendering a reflection for a virtual object in an electronic device in a Mixed Reality/Augmented Reality AR/MR space of a physical environment. The system and method may determine a reflective surface, estimate reflections, identify type of the reflective surfaces, etc., to render a photorealistic reflection for the virtual surface on a reflective surface of the physical environment. In addition, the system and method may render the reflection of the virtual object on the reflective surface of the physical environment using a ray-tracing method for a reflected content with the help of a semantic, material, and depth cues. The system and method may also consider different material properties of different reflective surfaces while rendering the reflection for the virtual object. For example, the reflection on a plane mirror vs the reflection on a shiny surface like a floor. The system and the method may also consider different shapes of the reflective surfaces, for example, a plane rectangular mirror vs a convex round mirror to render the reflection for the virtual object in the electronic device. The system and method as disclosed may modify the physical environment using a Reflective Surface Rendering Map operation based on a position of the virtual object inserted in the physical environment, unlike the existing art which modifies the virtual object, inserted in the physical environment, based on a condition, for example, lighting, of the physical environment. The system and method as proposed enable seamless blending of the virtual object, having a 3-dimensional (3D) structure, in the AR/MR space of the physical environment to enhance the user experience or to provide a seamless user experience.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Embodiments of the disclosure will be described below in detail with reference to the accompanying drawings.

FIG. 2 illustrates an environment 200 including a system 204 communicably coupled with an electronic device 202, according to an embodiment of the disclosure.

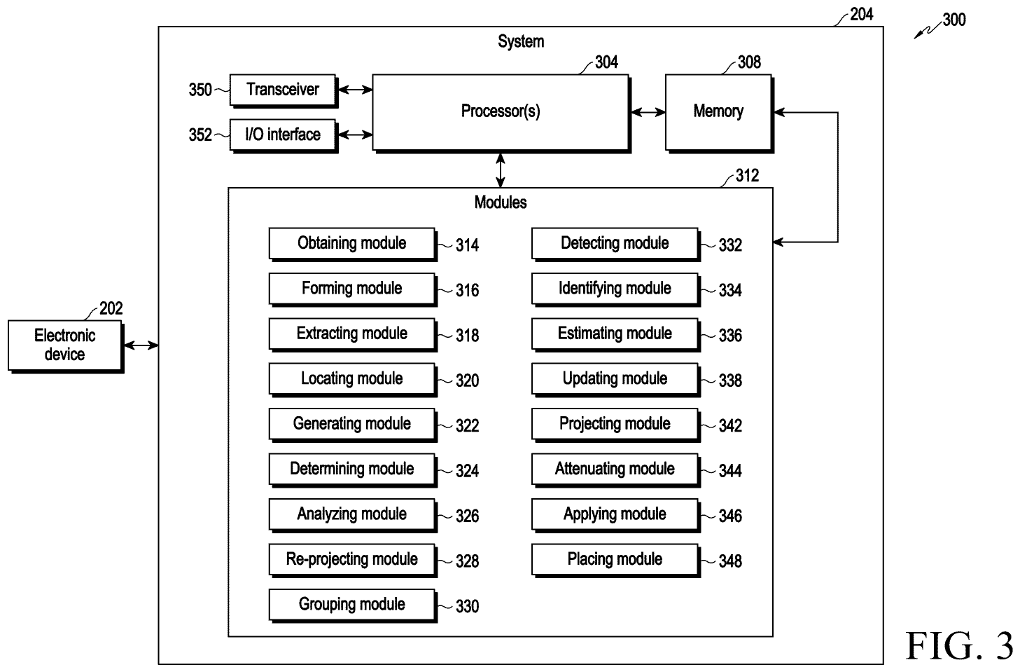

FIG. 3 illustrates a block diagram 300 of a system 204 in connection with an electronic device 202, according to an embodiment of the disclosure.

In an embodiment, the electronic device 202 (interchangeably referred to as a device 202) may be a smartphone, or any other electronic device having a camera that is known in the art, without departing from the scope of the disclosure. In an embodiment, the device 202 may be configured to support an augmented reality/mixed reality (AR/MR) space, where a virtual object is overlaid in a physical environment, without departing from the scope of the disclosure. In another embodiment, the system 204 may be communicatively coupled with the device 202. In another embodiment, the system 204 may be deployed within the device 202, without departing from the scope of the disclosure. The system 204 may be configured to render a reflection for the virtual object in the device 202, without departing from the scope of the disclosure.

In one embodiment, the system 204 may include, but is not limited to, at least one processor 304 (referred to here as a processor 304), memory 308, and a plurality of modules 312 among other examples which are explained in detail in subsequent paragraphs. The processor 304 may be communicatively coupled with the memory 308. Further, the system 204 may include an Input/Output (I/O) interface 352 and a transceiver 350. In some embodiments where the system 204 may be implemented as a standalone entity at a server/cloud architecture, the system 204 may be in communication with multiple user equipment to receive data from each of the multiple devices, and the details provided below with respect to the system 204 and the device 202, are applicable for the system 204 and the multiple user devices as well.

In another embodiment, the processor 304 may be communicatively coupled with the memory 308, without departing from the scope of the disclosure. The processor 304 may be operatively coupled to each of the I/O interface 352, the plurality of modules 312, the transceiver 350, and the memory 308. In one embodiment, the processor 304 may include a graphical processing unit (GPU) and/or an artificial intelligence engine (AIE). The processor 304 may include at least one data processor for executing processes in a virtual storage area network. The processor 304 may include specialized processing units such as integrated system (bus) controllers, memory management control units, floating point units, graphics processing units, digital signal processing units, etc. In one embodiment, the processor 304 may include a central processing unit (CPU), a graphics processing unit (GPU), or both. The processor 304 may be one or more general processors, digital signal processors, application-specific integrated circuits, field-programmable gate arrays, servers, networks, digital circuits, analog circuits, combinations thereof, or other now-known or later developed devices for analyzing and processing data. The processor 304 may execute a software program, such as code generated manually (i.e., programmed) to perform the desired operation.

The processor 304 may be disposed in communication with one or more input/output (I/O) devices via the I/O interface 352. In various embodiments, the processor 304 may communicate with the device 202 using the I/O interface 352. In some embodiments, the I/O interface 352 may be implemented within the device 202. The I/O interface 352 may employ communication code-division multiple access (CDMA), high-speed packet access (HSPA+), global system for mobile communications (GSM), long-term evolution (LTE), WiMax, or the like. In an embodiment, the I/O interface 352 may enable input and output to and from the system 204 using suitable devices such as, but not limited to, display, keyboard, mouse, touch screen, microphone, speaker, and so forth.

Using the I/O interface 352, the system 204 may communicate with one or more I/O devices, specifically, the device 202, to which the system 204 renders the reflection for the virtual object. In an example, the input device may be an antenna, microphone, touch screen, touchpad, storage device, transceiver, video device/source, etc. The output devices may be a video display (e.g., cathode ray tube (CRT), liquid crystal display (LCD), light-emitting diode (LED), plasma, Plasma Display Panel (PDP), Organic light-emitting diode display (OLED) or the like), audio speaker, etc.

The processor 304 may be disposed in communication with a communication network via a network interface. In one embodiment, the network interface may be the I/O interface 352. The network interface may connect to the communication network to enable the connection of the system 204 with the device 202. The network interface may employ connection protocols including, without limitation, direct connect, Ethernet (e.g., twisted pair 10/100/1000 Base T), transmission control protocol/internet protocol (TCP/IP), token ring, Institute of Electrical and Electronics Engineers (IEEE) 802.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 204 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The transceiver 350 may be configured to receive and/or transmit signals to and from the device 202. In another embodiment, the database may be configured to store the information as required by the plurality of modules 312 and the processor 304 to perform one or more functions for rendering the reflection for the virtual object, on the device 202.

The memory 308 may be communicatively coupled to the processor 304. The memory 308 may be configured to store data, and instructions executable by the processor 304 to perform the one or more methods disclosed herein throughout the disclosure. In an embodiment, the memory 308 may be provided within the device 202. In another embodiment, the memory 308 may be provided within the system 204 being remote from the device 202. In yet another embodiment, the memory 308 may communicate with the processor 304 via a bus within the system 204. In yet another embodiment, the memory 308 may be located remote from the processor 304 and may be in communication with the processor 304 via a network. The memory 308 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In one example, the memory 308 may include a cache or random-access memory for the processor 304. In alternative examples, the memory 308 is separate from the processor 304, such as a cache memory of a processor, the system memory, or other memory. The memory 308 may be an external storage device or database for storing data. The memory 308 may be, for example, operable to store instructions executable by the processor 304. The functions, acts, or tasks illustrated in the figures or described may be performed by the programmed processor 304 for executing the instructions stored in the memory 308. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

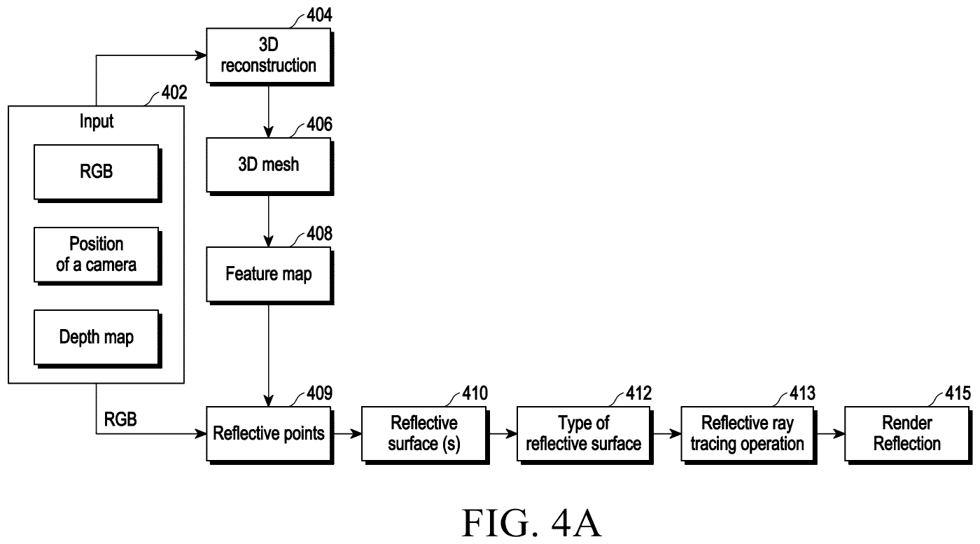

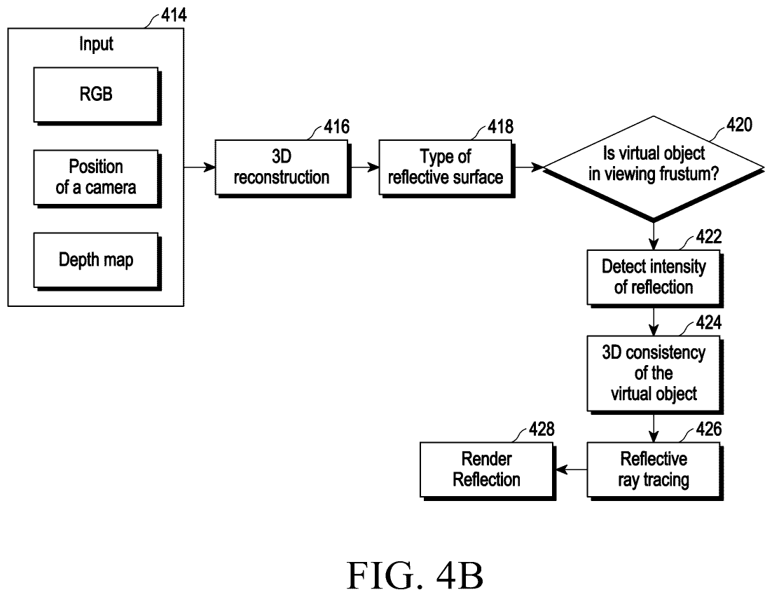

In various embodiments, the plurality of modules 312 may be included within the memory 308. The memory 308 may further include a database to store data. The plurality of modules 312 may include a set of instructions that may be executed to cause the system 204, in particular, the processor 304 of the system 204, to perform any one or more of the methods/processes disclosed herein. The plurality of modules 312 may be configured to perform the steps of the disclosure using the data stored in the database. For instance, the plurality of modules 312 may be configured to perform the steps disclosed in FIGS. 4A, 4B, 5, 6, 7A, 7B, 8, and 9A to 9F.

In an embodiment, each of the plurality of modules 312 may be a hardware unit that may be outside the memory 308. The memory 308 may include an operating system for performing one or more tasks of the system 204, as performed by a generic operating system.

In an example, the modules 312 may include an obtaining module 314, a forming module 316, an extracting module 318, a locating module 320, a generating module 322, a determining module 324, an analyzing module 326, a re-projecting module 328, a grouping module 330, a detecting module 332, an identifying module 334, an estimating module 336, an updating module 338, a projecting module 342, an attenuating module 344, an applying module 346, and a placing module 348. Each of the obtaining module 314, the forming module 316, the extracting module 318, the locating module 320, the generating module 322, the determining module 324, the analyzing module 326, the re-projecting module 328, the grouping module 330, the detecting module 332, the identifying module 334, the estimating module 336, the updating module 338, the projecting module 342, the attenuating module 344, the applying module 346, and the placing module 348 may be in communication with each other. Each of the obtaining module 314, the forming module 316, the extracting module 318, the locating module 320, the generating module 322, the determining module 324, the analyzing module 326, the re-projecting module 328, the grouping module 330, the detecting module 332, the identifying module 334, the estimating module 336, the updating module 338, the projecting module 342, the attenuating module 344, the applying module 346, and the placing module 348 may be in communication with the processor 304.

Further, the disclosure contemplates a computer-readable medium that includes instructions or receives and executes instructions responsive to a propagated signal. The instructions may be transmitted or received over the network via a communication port or interface or using a bus (not shown). The communication port or interface may be a part of the processor 304 or may be a separate component. The communication port may be created in software or may be a physical connection in hardware.

The communication port may be configured to connect with the network, external media, the display, or any other components in the system, or combinations thereof. The connection with the network may be a physical connection, such as a wired Ethernet connection, or may be established wirelessly. The additional connections with other components of the system 204 may be physical or may be established wirelessly. The network may alternatively be directly connected to a bus. For the sake of brevity, the architecture and standard operations of the memory 308, the processor 304, the transceiver 350, and the I/O interface 352 are not discussed in detail.

In an embodiment, the working of the system 204 to render the reflection for the virtual object, in the device 202 is explained in detail. The processor 304, in conjunction with the obtaining module 314, the forming module 316, the extracting module 318, the locating module 320, the generating module 322, the determining module 324, the analyzing module 326, the re-projecting module 328, the grouping module 330, the detecting module 332, the identifying module 334, the estimating module 336, the updating module 338, the projecting module 342, the attenuating module 344, the applying module 346, and the placing module 348 may be configured to perform specific operations explained in later paragraphs in conjunction with FIGS. 4A, 4B, 5, 6, 7A, 7B, 8, and 9A to 9F.

FIGS. 4A and 4B illustrate operations performed by the system 204, according to various embodiments of the disclosure.

FIG. 4A illustrates a block diagram of the operation performed by the system 204, according to an embodiment of the disclosure.

FIG. 4B illustrates a flowchart of the operation performed by the system 204, according to an embodiment of the disclosure.

Referring to FIGS. 4A and 4B, at operation 414, the system 204 may be configured to receive an input 402 from the electronic device 202. The input may include, but is not limited to, Red, Green, and Blue (RGB) frames, a position of the camera, and a depth-map of an Augmented Reality scene visualized by a user. Further, based on the input, at operation 416, the system 204 may perform a 3-dimensional (3D) reconstruction 404 operation to form a 3D mesh 406. The system 204 may be configured to generate a feature map 408 based on the 3D mesh 306. The system 204 may be configured to generate reflective points 409 and thereafter, determine one or more reflective surfaces 410 based on the feature map 408. At operation 418, the system 204 may be configured to identify a surface material/type 412 of the determined one or more surface 410. At operation 420, the system 204 may determine if the virtual object may be placed in an estimated viewing frustum, where the virtual object reflects based on the identified type 412. At operation 422, the system 204 may determine an intensity of the reflection, when the virtual object may be placed in the estimated viewing frustum and reflects. At operation 424, the system 204 may localize the placement of the virtual object in the estimated viewing frustum. Further, at operations 426 and 428, the system 204 may perform a reflective ray tracer operation 413 on the virtual object placed in the estimated viewing frustum, and thereafter, render the reflection 415 for the virtual object.

The detailed operation performed by the system 204 may be explained in subsequent paragraphs in conjunction with FIGS. 4A, 4B, 5, 6, 7A, 7B, 8, and 9A to 9F.

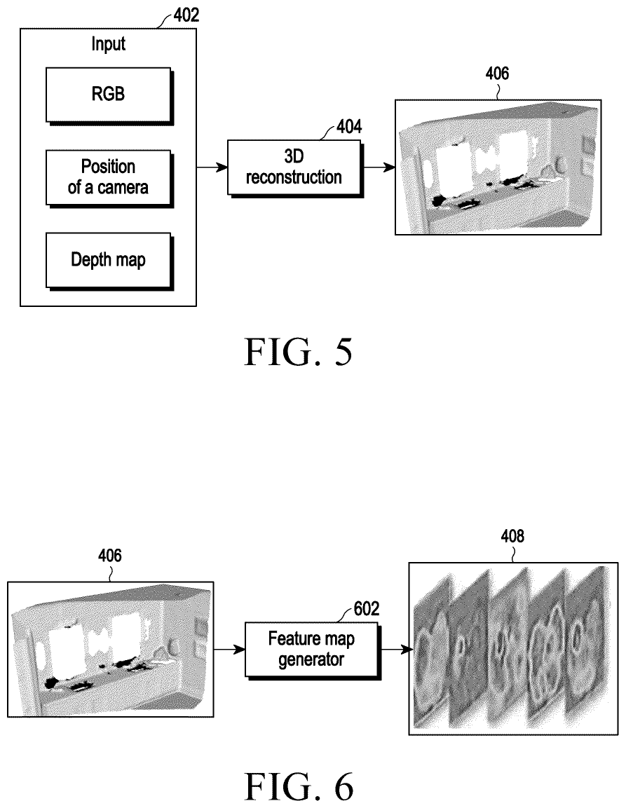

FIG. 5 illustrates a block diagram depicting the formation of the 3D mesh 406 by the system 204, according to an embodiment of the disclosure.

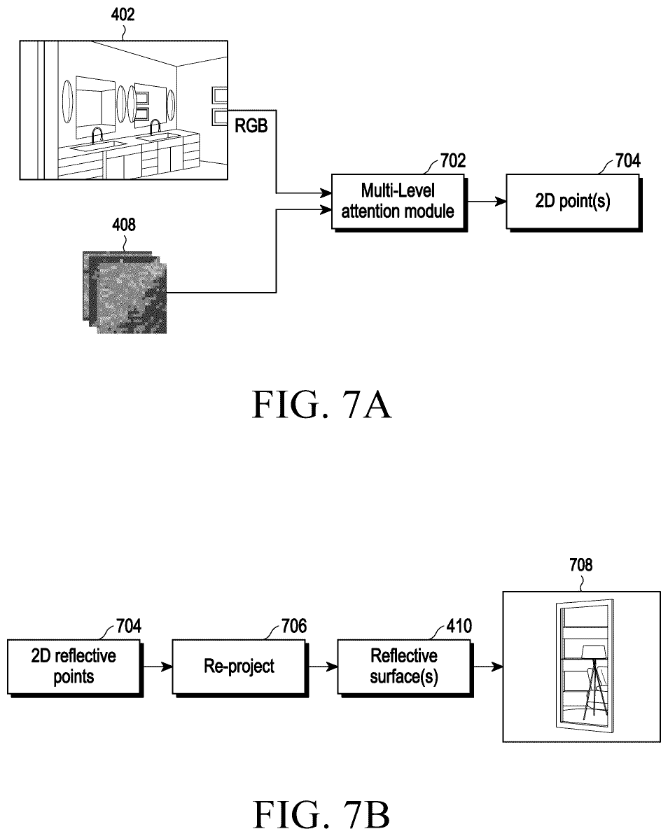

FIG. 6 illustrates a block diagram depicting the formation of the feature map 408 by the system 204, according to an embodiment of the disclosure FIG. 7A illustrates a block diagram depicting the formation of a plurality of 2D points by the system 204, according to an embodiment of the disclosure.

FIG. 7B illustrates a block diagram depicting a determination of the one or more reflective surfaces 410, according to an embodiment of the disclosure.

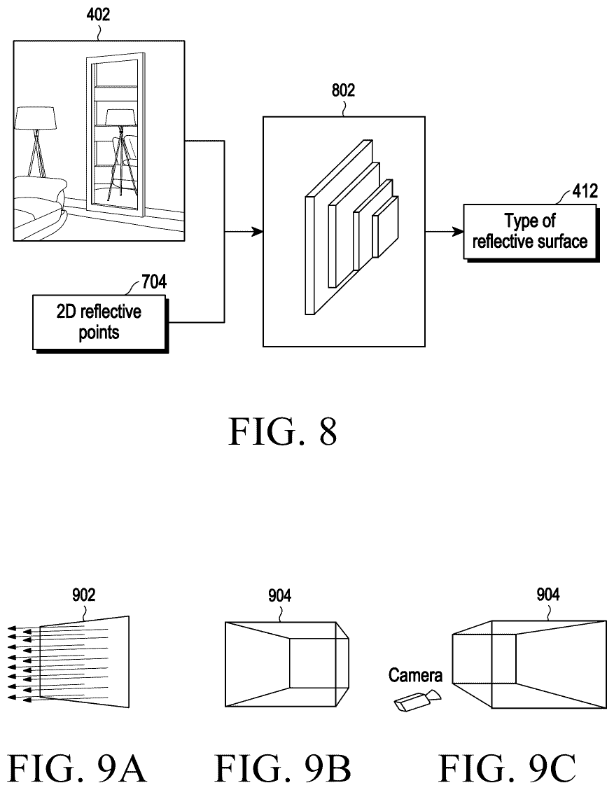

FIG. 8 illustrates a block diagram depicting an identification of the type 412 of the determined one or more reflective surfaces 410, according to an embodiment of the disclosure.

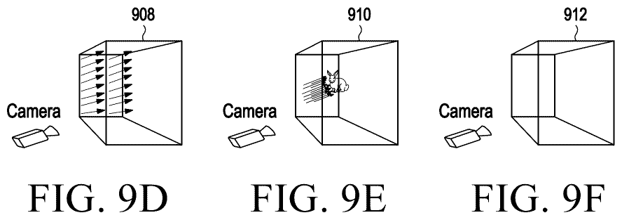

FIG. 9A illustrates an estimation of a surface normal 902 by the system 204, according to an embodiment of the disclosure.

FIGS. 9B and 9C illustrate estimations of the viewing frustum 904 in the system 204, according to various embodiments of the disclosure.

FIG. 9D illustrates a ray 908 projected by the system 204, according to an embodiment of the disclosure.

FIG. 9E illustrates an intersection 910 of the projected ray 908 and the virtual object, according to an embodiment of the disclosure.

FIG. 9F illustrates an attenuation 912 of the color in the system 204, according to an embodiment of the disclosure.

In an embodiment, referring to operation 414, the obtaining module 314 may be configured to obtain one or more Red, Green, and Blue (RGB) frames and the depth-map associated with the Augmented Reality (AR) scene visualized in the device 202 for the user. The detecting module 332 may be configured to detect the placement of the virtual object in the AR scene visualized in the device 202.

In another embodiment, referring to FIG. 5 and operation 416, the forming module 316 may be configured to form the 3D mesh 406 for a plurality of 3D points visualized (e.g., provided) in the AR scene based on the obtained one or more RGB frames (e.g., image frames) and the depth-map of the AR scene. In such an embodiment, the forming module 316 also considers a direction of viewing the AR scene to form the 3D mesh 406. During the 3D reconstruction operation 404, regions of a real-image, for example, dark regions, reflective regions, visualized in the AR scene, do not provide information related to depth. Thus, the 3D reconstruction may not be performed for a plurality of 3D points corresponding to the dark regions, reflective regions, etc. Therefore, a plurality of holes may be observed in the dark regions, reflective regions, etc. Further, the 3D mesh 406 may be formed for the plurality of 3D points, which may be visualized in the AR scene, along with the plurality of holes based on the obtained one or more RGB frames, the depth-map.

After forming the 3D mesh 406, referring to FIG. 6, the extracting module 318 may be configured to extract a plurality of noisy 3D points with missing depth in the formed 3D mesh 406. The noisy 3D points may be the plurality of holes as mentioned in the abovementioned paragraph, without departing from the scope of the disclosure. In such an embodiment, the noisy 3D points may be considered as feature points, without departing from the scope of the disclosure. The locating module 320 may be configured to locate a plurality of 2D points associated with the plurality of 3D points on the obtained one or more RGB frames. The generating module 322 may be configured to generate the feature map 408 based on the located plurality of 2D points by a feature map generator 602.

After generating the feature map 408, the determining module 324 may be configured to determine the one or more reflective surfaces 410 in the AR scene, based on the obtained RGB frames and the depth-map (e.g., depth information). In such an embodiment, referring to FIG. 7A, the analyzing module 326 may be configured to analyze the generated feature map 408 and the one or more RGB frames by a feature descriptor operation. This operation generates a plurality of 2D points 704 associated with the one or more reflective surfaces 410. In The feature map descriptor operation may use a multi-level attention module 702 to analyze the generated feature map 408 and the one or more RGB frames to generate the plurality of 2D points 704. In an embodiment, the multi-level attention module 702 may be a pre-trained Artificial Intelligence model (AI model), without departing from the scope of the disclosure. The multi-level attention module 702 may be configured to apply attention mechanisms on and around the feature points in the feature map 408 to generate the plurality of 2D points 704. The plurality of 2D points 704 may be reflective points 409, without departing from the scope of the disclosure.

Referring to FIG. 7B, the re-projecting module 328 may be configured to re-project 706 the generated plurality of 2D points 704 in a plurality of 3D points associated with the one or more reflective surfaces by a reflective surface map generator. The grouping module 330 may be configured to group the plurality of 3D points to provide the determined one or more reflective surfaces 410. Further, the generating module 322 may be configured to generate the reflection map 708 for the determined one or more reflective surfaces 410 which is explained in a later paragraph.

After determining the one or reflective surfaces 410, at operation 418, the identifying module 334 may be configured to identify the type 412 of the determined one or more reflective surfaces 410 in the AR scene. In such an embodiment, the analyzing module 326 may be, for example, configured to analyze the obtained one or more RGB frames and the determined one or more reflective surfaces 410 by a surface material classifier operation performed by a surface material classifier 802. This operation identifies the type 412 of the determined one or more reflective surfaces 410 from a plurality of predetermined types of one or more reflective surfaces 410. In an embodiment, the surface material classifier 802 may be based on Convolutional Neural Networks (CNN) without departing from the scope of the disclosure. In an embodiment, the plurality of predetermined types includes, but is not limited to, at least one of a mirror type, a metallic type, a matte type, and a glossy type, without departing from the scope of the disclosure.

The generating module 322 may be configured to generate the reflection map 708 for the determined one or more reflective surfaces 410 based on the placement of the virtual object, the identified type 412 of the determined one or more reflective surfaces 410. In such an embodiment, the generating module 322 may be configured to generate the reflection map 708 by a reflective ray tracer operation 413 by using at least one parameter. The at least one parameter may include one of a semantic cue, a depth cue, and a material cue. The semantic cue is provided from the determined one or more reflective surfaces 410. The depth cue is provided from the depth-map associated with the AR scene. The material cue is provided from the identified type 412 of the determined one or more reflective surfaces 410.

In such an embodiment, referring to FIG. 9A, the analyzing module 326 may be configured to analyze the determined one or more reflective surfaces 410, the identified type 412, and the obtained depth-map of the AR scene. The estimating module 336 may be configured to estimate the surface normal 902 to the determined one or more reflective surfaces 410 based on the analyzed determined one or more reflective surfaces 410, the identified type 412, and the obtained depth-map. This configuration provides information on the geometry of the determined one or more reflective surfaces 410, i.e., a point of reflections in the determined one or more reflective surfaces 410.

Referring to FIGS. 9B and 9C, the estimating module 336 may be configured to estimate the viewing frustum 904 associated with the obtained depth-map based on a viewing angle of the AR scene and a position of the analyzed determined one or more reflective surfaces 410. This operation maps the virtual object in the analyzed determined one or more reflective surfaces 410 with an object of the physical environment. In such an embodiment, the estimated viewing frustum 904 may change/vary based on the viewing angle of the AR scene. Particularly, initially, the estimated viewing frustum 904 depends on the estimated surface normal 902. When the viewing angle of the AR scene varies, then the estimated viewing frustum 904 also varies based on the viewing angle of the AR scene. This operation ensures that the virtual object remains in the estimated viewing frustum.

The generating module 322 may be configured to generate the reflection map 708 for the analyzed determined one or more reflective surfaces 410 based on the estimated viewing frustum 904. In an embodiment, the reflection map 708 may include a reflective surface rendering color, without departing from the scope of the disclosure. The updating module 338 may be configured to update the reflection map 708 based on the estimated viewing frustum 904 of the AR scene from the device 202 by the user. The reflection map 708 may be performed for the pixels that may be impacted by the placement of the virtual object. For the remaining pixels, normal rendering may be applied, without departing from the scope of the disclosure. This operation improves the time performance of the rendering for the virtual object.

Referring to FIG. 9D, the projecting module 342 may be configured to project a ray 908 by the analyzed determined one or more reflective surfaces 410. The ray 908 may be projected based on the estimated surface normal 902 and a direction of viewing the AR scene by the user for each pixel of the analyzed determined one or more reflective surfaces 410. This operation, for example, assists in the occlusion and view-dependent effects by projecting the ray 908 from the pixel in the determined one or more reflective surfaces 410.

Referring to FIG. 9E, the determining module 324 may be configured to determine an intersection 910 of the projected ray 908 with the virtual object to estimate a color, from the reflective surface rendering color, corresponding to a blending mask. Herein, when the intersection 910 of the virtual object with the projected ray occurs initially, then the virtual object may be rendered. The rendering may be done locally for each pixel and thus, partial occlusions may be executed by the system 204.

Referring to FIG. 9F, the attenuating module 344 may be configured to attenuate 912 the estimated color based on one or more material properties of the virtual object. The applying module 346 may be configured to apply the generated reflection map 708 by matting the attenuated estimated color using a reflective surface rendering map, and the reflective surface rendering color on a real frame (e.g., a RGB frame and/or an image frame) of the AR scene.

The applying module 346 may be configured to apply the generated reflection map 708 on the determined one or more reflective surfaces 410 to render the reflection 415 of the virtual object in the device 202. In another embodiment, to render the reflection 415 of the virtual object, the placing module 348 may be configured to place the virtual object in the estimated viewing frustum 904 of the determined one or more reflective surfaces 410. Further, at operation 420, the determining module 324 may be configured to determine if the virtual object placed in the region of the estimated viewing frustum 904 may reflect. When the virtual object may reflect, at operation 422, the analyzing module 326 may be configured to analyze the intensity and nature of the reflections. Further, based on the identified type 412, at operation 424, the determining module 324 may be configured to determine the intensity/strength of the reflection to be rendered. Thereafter, the placement of the virtual object may be localized in the estimated viewing frustum by use of the depth-map or the 3D mesh 406. Lastly, at operations 426 and 428, the updating module 338 may be configured to update the determined one or more reflective surfaces 410 by the reflective ray tracer operation 413 by rendering the reflection 415 for the virtual object.

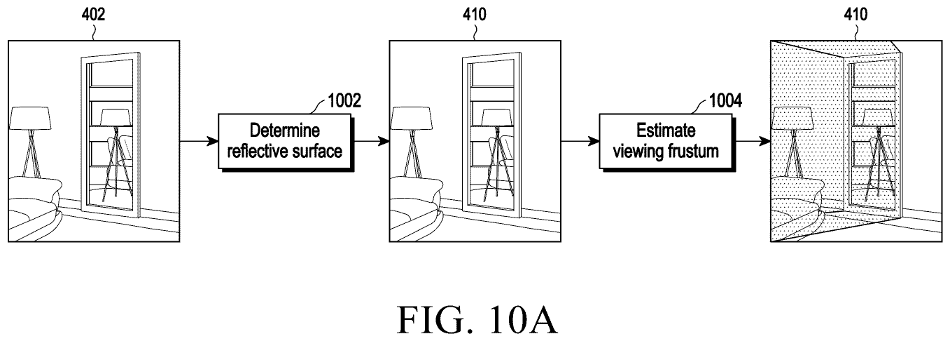

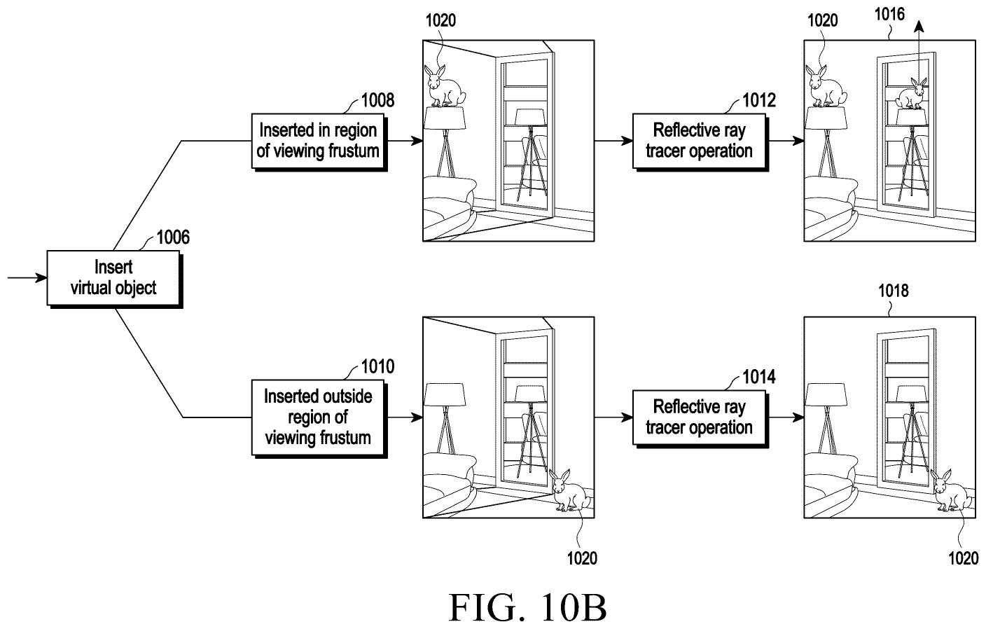

FIGS. 10A and 10B illustrate the implementation of the system 204, without departing from the scope according to various embodiments of the disclosure.

Initially, at operation 1002, the determining module 324 may be configured to determine the one or more reflective surfaces 410, based on the input 402. Further, based on the determined one or more reflective surfaces 410, at operation 1004, the estimating module 336 may be configured to estimate the viewing frustum 904. Thereafter, at operation 1006, the virtual object, i.e., the rabbit 1020 may be placed/inserted into the AR scene. At operation 1008, the virtual object may be inserted into the region of the estimated viewing frustum 904. Thereafter, at operation 1012, the updating module 338 may be configured to update the determined one or more reflective surfaces 410, i.e., a mirror, by the reflective ray tracer operation by rendering the reflection for the virtual object, i.e., the rabbit 1004, as shown at operation 1016.

Similarly, at operation 1010, the virtual object may be inserted outside the region of the estimated viewing frustum 904. Thus, the determined one or more reflective surfaces 410, i.e., a mirror, may not be updated as the updating module 338 while performing the reflective ray tracer operation, at operation 1014, does not detect the virtual object in the estimated viewing frustum 904. Thus, the determined one or more reflective surfaces 410 remains the same as shown at operation 1018.

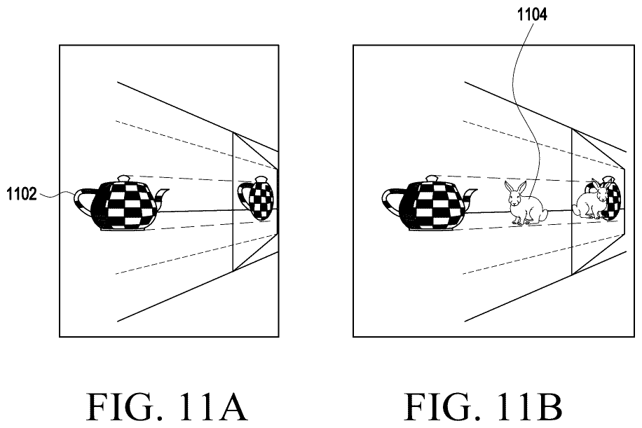

FIGS. 11A and 11B illustrate examples of the operation performed by the system 204, according to various embodiments of the disclosure.

Referring to FIG. 11A, an object 1102 present in the physical environment may be visible in a mirror. Thereafter, referring to FIG. 11B, the virtual object, i.e., a rabbit 1104, may be inserted between the mirror and the object 1002. Further, the system 204 may perform the operation as discussed in the abovementioned paragraph (From FIGS. 4A, 4B, 5, 6, 7A, 7B, 8, and 9A to 9F) to render the reflection for the rabbit 1004 on the mirror while executing the occlusion. From FIG. 11B, it has been observed that the object 1002 is occluded in the mirror and partially visible regions, i.e., tea-pot handle, based on the geometry, rendered in the mirror.

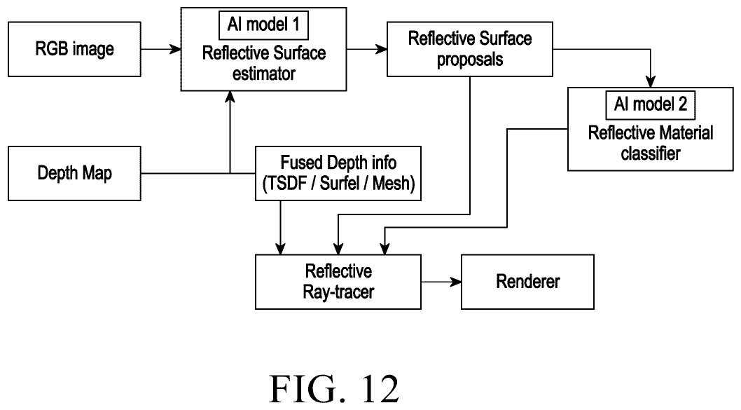

FIG. 12 is a block diagram illustrating rendering reflection of a virtual object photo-realistically using semantic cues from the estimated reflection map and depth cues from the input depth modality/available 3D volume representation.

Referring to FIG. 12, the system 204 and/or the electronic device 202 obtain the RGB frame, depth-map from sensor and fused depth maps from TSDF/Surfel/Mesh 3D representation. According to an embodiment of the present disclosure, the reflective surface estimator is configured to create map of reflective surfaces. According to an embodiment of the present disclosure, the surface material classifier configured to classify the surface into different types such as specular, diffuse, shiny, etc. According to an embodiment of the present disclosure, the reflective ray-tracer is configured to take (e.g., obtain) the semantic cues from reflective surface estimator, material cues from the material classifier and depth cues from the fused depth or raw-depth to create a rendering of the reflection of the virtual object. According to an embodiment of the present disclosure, on receiving a request to render virtual object, the system 204 and/or the electronic device 202 are configured to detect regions to be modified. For example, the system 204 and/or the electronic device 202 are configured to determine if the inserted objects fall in the scene getting reflected in the surface. According to an embodiment of the present disclosure, the system 204 and/or the electronic device 202 are configured to analyze reflection. For example, the system 204 and/or the electronic device 202 are configured to analyze the intensity and nature of the reflections, then using the information from the type of material of the surface, determine the strength of the reflection to be rendered. According to an embodiment of the present disclosure, the system 204 and/or the electronic device 202 are configured to identify 3D consistency of the object in the reflected scene. For example, the system 204 and/or the electronic device 202 are configured to localize the position of the inserted virtual object in the reflective scene using either depth map of the current frame or the reconstructed 3D world to render effects like occlusion etc.

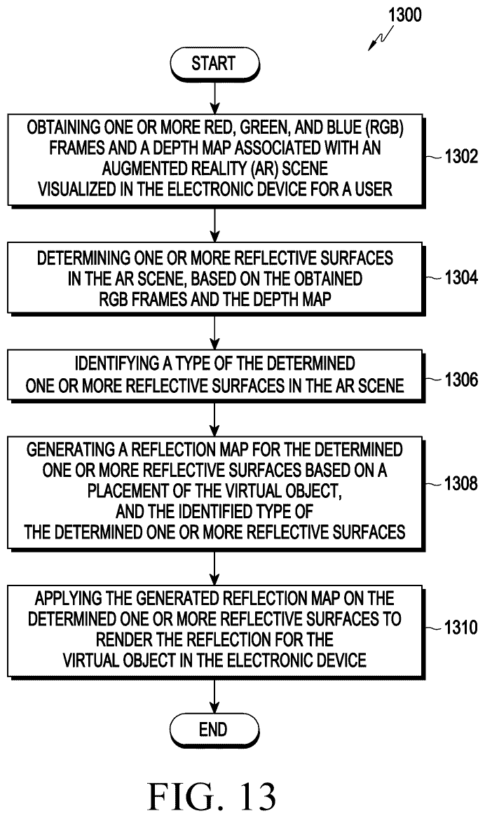

FIG. 13 illustrates a method performed by the system to render reflection for the virtual object in the device, according to an embodiment of the disclosure.

The method 1300 includes a series of operations shown at operation 1302 through operation 1310 of FIG. 13. The method 1300 may be performed by the system 204 in conjunction with modules 312, the details of which are explained in conjunction with FIGS. 3, 4A, 4B, 5, 6, 7A, 7B, 8, and 9A to 9F and the same are not repeated here for the sake of brevity in the disclosure. The method 1300 begins at operation 1302.

At operation 1302, the method 1300 includes obtaining the one or more Red, Green, and Blue (RGB) frames and the depth-map associated with the Augmented Reality (AR) scene visualized in the electronic device 202 for the user. The method 1200 includes detecting the placement of the virtual object in the AR scene visualized in the device 202.

The method 1300 includes forming the 3D mesh 406 for the plurality of 3D points visualized in the AR scene based on the obtained one or more RGB frames and the depth-map of the AR scene. In another embodiment, the method 1300 includes extracting a plurality of noisy 3D points with missing depth in the formed 3D mesh 406. The method 1300 includes locating the plurality of 2D points associated with the plurality of 3D points on the obtained one or more RGB frames. The method 1200 includes generating the feature map 408 based on the located plurality of 2D points by the feature map generator 602.

At operation 1304, the method 1300 includes determining one or more reflective surfaces 410 in the AR scene, based on the obtained RGB frames and the depth-map. The method 1300 further includes determining whether at least one reflective surface is included in the AR scene (e.g., at least one RGB frame). The method 1300 includes analyzing the generated feature map 408 and the one or more RGB frames by the feature descriptor operation to generate the plurality of 2D points associated with the one or more reflective surfaces 410. The method 1300 includes, for example, re-projecting the generated plurality of 2D points in the plurality of 3D points associated with the one or more reflective surfaces 410 by the reflective surface map generator. The method 1300 includes grouping the plurality of 3D points to provide the determined one or more reflective surfaces 410.

At operation 1306, the method 1300 includes identifying the type 412 of the determined one or more reflective surfaces 410 in the AR scene. The method 1200 includes analyzing the obtained one or more RGB frames and the determined one or more reflective surfaces 410 by the surface material classifier operation for identifying the type 412 of the determined one or more reflective surfaces 410 from the plurality of predetermined types of the determined one or more reflective surfaces 410. In one embodiment, the plurality of predetermined types may include, but is not limited to, the at least one of the mirror type, the metallic type, the matte type, and the glossy type.

At operation 1308, the method 1300 includes generating the reflection map 708 for the determined one or more reflective surfaces 410 based on the placement of the virtual object, the identified type 412 of the determined one or more reflective surfaces 410. The method 1300 includes, for example, generating the reflection map 708 by the reflective ray tracer operation by using the at least one parameter. The at least one parameter may include the at least one of the semantic cue, the depth cue, and the material cue. The semantic cue is provided from the determined one or more reflective surfaces 410. The depth cue may be provided from the depth-map associated with the AR scene. The material cue may be provided from the identified type 412 of the determined one or more reflective surfaces 410.

The method 1300 includes analyzing the determined one or more reflective surfaces 410, the identified type 412, and the obtained depth-map of the AR scene. The method 1300 includes estimating the surface normal 902 to the determined one or more reflective surfaces 410 based on the analyzed determined one or more reflective surfaces 410, the identified type 412, and the obtained depth-map. The method 1200 includes, for example, estimating the viewing frustum 904 associated with the obtained depth-map based on the viewing angle of the AR scene and the position of the analyzed determined one or more reflective surfaces 410. The method 1200 includes generating the reflection map 708 for the analyzed determined one or more reflective surfaces 410 based on the estimated viewing frustum 904. The reflection map 708 may include the reflective surface rendering color.

The method 1300 includes updating the reflection map 708 based on the estimated viewing frustum 904 of the AR scene from the electronic device 202 by the user. The method 1300 includes projecting the ray 908 by the analyzed determined one or more reflective surfaces 410 based on the estimated surface normal 902 and the direction of viewing the AR scene by the user for each pixel of the analyzed determined one or more reflective surfaces 410. The method 1200 includes, for example, determining the intersection 910 of the projected ray 908 with the virtual object to estimate the color, from the reflective surface rendering color, corresponding to the blending mask. The method 1300 includes attenuating 912 the estimated color based on one or more material properties of the virtual object. The method 1300 includes applying the generated reflection map 708 by matting the attenuated estimated color using the reflective surface rendering map, and the reflective surface rendering color on the real frame of the AR scene. The reflection map includes a first reflective surface corresponding to the at least one reflective surface.

At operation 1310, the method 1200 includes applying the generated reflection map 708 on the determined one or more reflective surfaces 410 to render the reflection of the virtual object in the electronic device 202. The method 1300 includes, for example, placing the virtual object in the estimated viewing frustum 904 of the determined one or more reflective surfaces 410. The method 1200 includes updating the determined one or more reflective surfaces 410 by the reflective ray tracer operation by rendering the reflection for the virtual object.

Further, the system 204 and the method 1300 as disclosed may be used in a head-mounted device (HMD) device and gaming industry having AR/MR application.

As would be gathered, the system 204 and the method 1200 as disclosed ensure a seamless experience for the user by rendering the reflection for the virtual object in the device 202 in the AR/MR scenario. The system 204 and the method 1200 consider the geometry of the physical environment, thus handling the scenario where the virtual object occludes the object of the physical environment completely/partially. The system 204 and the method 1200 accurately determine the one or more reflective surfaces 410 and also, identify the type of the determined one or more reflective surface 410, this ensures the photo-realism experience to the user. The system 204 and the method 1200 as disclosed consider the estimated surface normal 902 in which the determined one or more reflective regions 410 and the virtual objects are present. Furthermore, the system 204 and the method 1200 as disclosed also consider viewing angle of the AR scene and the position of the camera to provide accurate rendering for the virtual object in the device 202.

The system 204 and the method 1200 are also compatible to be used in different scenarios, i.e., when the determined one or more reflective surface 410 is a convex mirror and when the determined one or more reflective surface 410 is a concave mirror or a plane mirror, thus maintaining the rendering of the reflection for the virtual object efficiently.

In this application, the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

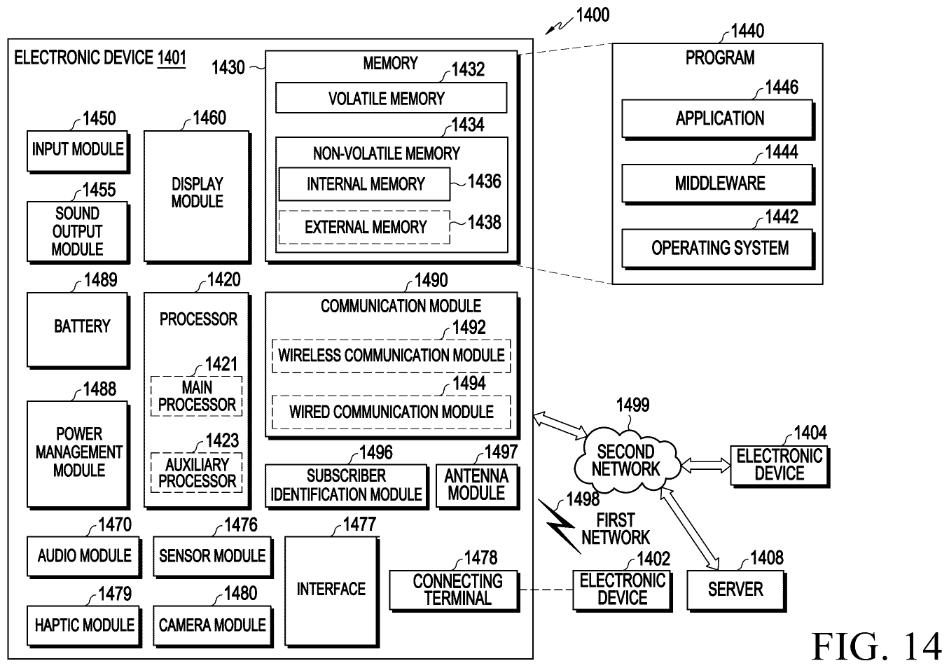

FIG. 14 is a block diagram illustrating an electronic device 1401 (e.g., the electronic device 202 and/or the system 204) in a network environment 1400 according to various embodiments. The functions, operations, acts, and/or tasks illustrated in the figures of the present disclosure or described in the present disclosure may be performed by the electronic device 1401.

Referring to FIG. 14, the electronic device 1401 in the network environment 1400 may communicate with an electronic device 1402 via a first network 1498 (e.g., a short-range wireless communication network), or at least one of an electronic device 1404 or a server 1408 via a second network 1499 (e.g., a long-range wireless communication network). According to an embodiment, the electronic device 1401 may communicate with the electronic device 1404 via the server 1408. According to an embodiment, the electronic device 1401 may include a processor 1420, memory 1430, an input module 1450, a sound output module 1455, a display module 1460, an audio module 1470, a sensor module 1476, an interface 1477, a connecting terminal 1478, a haptic module 1479, a camera module 1480, a power management module 1488, a battery 1489, a communication module 1490, a subscriber identification module (SIM) 1496, or an antenna module 1497. In some embodiments, at least one of the components (e.g., the connecting terminal 1478) may be omitted from the electronic device 1401, or one or more other components may be added in the electronic device 1401. In some embodiments, some of the components (e.g., the sensor module 1476, the camera module 1480, or the antenna module 1497) may be implemented as a single component (e.g., the display module 1460).

The processor 1420 may execute, for example, software (e.g., a program 1440) to control at least one other component (e.g., a hardware or software component) of the electronic device 1401 coupled with the processor 1420, and may perform various data processing or computation. According to one embodiment, as at least part of the data processing or computation, the processor 1420 may store a command or data received from another component (e.g., the sensor module 1476 or the communication module 1490) in volatile memory 1432, process the command or the data stored in the volatile memory 1432, and store resulting data in non-volatile memory 1434. According to an embodiment, the processor 1420 may include a main processor 1421 (e.g., a central processing unit (CPU) or an application processor (AP)), or an auxiliary processor 1423 (e.g., a graphics processing unit (GPU), a neural processing unit (NPU), an image signal processor (ISP), a sensor hub processor, or a communication processor (CP)) that is operable independently from, or in conjunction with, the main processor 1421. For example, when the electronic device 1401 includes the main processor 1421 and the auxiliary processor 1423, the auxiliary processor 1423 may be adapted to consume less power than the main processor 1421, or to be specific to a specified function. The auxiliary processor 1423 may be implemented as separate from, or as part of the main processor 1421.

The auxiliary processor 1423 may control at least some of functions or states related to at least one component (e.g., the display module 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). According to an embodiment, the auxiliary processor 1423 (e.g., an image signal processor or a communication processor) may be implemented as part of another component (e.g., the camera module 1480 or the communication module 1490) functionally related to the auxiliary processor 1423. According to an embodiment, the auxiliary processor 1423 (e.g., the neural processing unit) may include a hardware structure specified for artificial intelligence model processing. An artificial intelligence model may be generated by machine learning. Such learning may be performed, e.g., by the electronic device 1401 where the artificial intelligence is performed or via a separate server (e.g., the server 1408). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1430 may store various data used by at least one component (e.g., the processor 1420 or the sensor module 1476) of the electronic device 1401. The various data may include, for example, software (e.g., the program 1440) and input data or output data for a command related thererto. The memory 1430 may include the volatile memory 1432 or the non-volatile memory 1434.

The program 1440 may be stored in the memory 1430 as software, and may include, for example, an operating system (OS) 1442, middleware 1444, or an application 1446.

The input module 1450 may receive a command or data to be used by another component (e.g., the processor 1420) of the electronic device 1401, from the outside (e.g., a user) of the electronic device 1401. The input module 1450 may include, for example, a microphone, a mouse, a keyboard, a key (e.g., a button), or a digital pen (e.g., a stylus pen).

The sound output module 1455 may output sound signals to the outside of the electronic device 1401. The sound output module 1455 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1460 may visually provide information to the outside (e.g., a user) of the electronic device 1401. The display module 1460 may include, for example, a display, a hologram device, or a projector and control circuitry to control a corresponding one of the display, hologram device, and projector. According to an embodiment, the display module 1460 may include a touch sensor adapted to detect a touch, or a pressure sensor adapted to measure the intensity of force incurred by the touch.

The audio module 1470 may convert a sound into an electrical signal and vice versa. According to an embodiment, the audio module 1470 may obtain the sound via the input module 1450, or output the sound via the sound output module 1455 or a headphone of an external electronic device (e.g., an electronic device 1402) directly (e.g., wiredly) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. According to an embodiment, the sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device (e.g., the electronic device 1402) directly (e.g., wiredly) or wirelessly. According to an embodiment, the interface 1477 may include, for example, a high definition multimedia interface (HDMI), a universal serial bus (USB) interface, a secure digital (SD) card interface, or an audio interface.

A connecting terminal 1478 may include a connector via which the electronic device 1401 may be physically connected with the external electronic device (e.g., the electronic device 1402). According to an embodiment, the connecting terminal 1478 may include, for example, a HDMI connector, a USB connector, a SD card connector, or an audio connector (e.g., a headphone connector).

The haptic module 1479 may convert an electrical signal into a mechanical stimulus (e.g., a vibration or a movement) or electrical stimulus which may be recognized by a user via his tactile sensation or kinesthetic sensation. According to an embodiment, the haptic module 1479 may include, for example, a motor, a piezoelectric element, or an electric stimulator.

The camera module 1480 may capture a still image or moving images. According to an embodiment, the camera module 1480 may include one or more lenses, image sensors, image signal processors, or flashes.

The power management module 1488 may manage power supplied to the electronic device 1401. According to one embodiment, the power management module 1488 may be implemented as at least part of, for example, a power management integrated circuit (PMIC).

The battery 1489 may supply power to at least one component of the electronic device 1401. According to an embodiment, the battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the application processor (AP)) and supports a direct (e.g., wired) communication or a wireless communication. According to an embodiment, the communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as Bluetooth™, wireless-fidelity (Wi-Fi) direct, or infrared data association (IrDA)) or the second network 1499 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The wireless communication module 1492 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1492 may support a high-frequency band (e.g., the mmWave band) to achieve, e.g., a high data transmission rate. The wireless communication module 1492 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1492 may support various requirements specified in the electronic device 1401, an external electronic device (e.g., the electronic device 1404), or a network system (e.g., the second network 1499). According to an embodiment, the wireless communication module 1492 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1497 may transmit or receive a signal or power to or from the outside (e.g., the external electronic device) of the electronic device 1401. According to an embodiment, the antenna module 1497 may include an antenna including a radiating element composed of a conductive material or a conductive pattern formed in or on a substrate (e.g., a printed circuit board (PCB)). According to an embodiment, the antenna module 1497 may include a plurality of antennas (e.g., array antennas). In such a case, at least one antenna appropriate for a communication scheme used in the communication network, such as the first network 1498 or the second network 1499, may be selected, for example, by the communication module 1490 (e.g., the wireless communication module 1492) from the plurality of antennas. The signal or the power may then be transmitted or received between the communication module 1490 and the external electronic device via the selected at least one antenna. According to an embodiment, another component (e.g., a radio frequency integrated circuit (RFIC)) other than the radiating element may be additionally formed as part of the antenna module 1497.

According to various embodiments, the antenna module 1497 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1401 and the external electronic device 1404 via the server 1408 coupled with the second network 1499. Each of the electronic devices 1402 or 1404 may be a device of a same type as, or a different type, from the electronic device 1401. According to an embodiment, all or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1401. The electronic device 1401 may provide the outcome, with or without further processing of the outcome, as at least part of a reply to the request. To that end, a cloud computing, distributed computing, mobile edge computing (MEC), or client-server computing technology may be used, for example. The electronic device 1401 may provide ultra low-latency services using, e.g., distributed computing or mobile edge computing. In another embodiment, the external electronic device 1404 may include an internet-of-things (IoT) device. The server 1408 may be an intelligent server using machine learning and/or a neural network. According to an embodiment, the external electronic device 1404 or the server 1408 may be included in the second network 1499. The electronic device 1401 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1440) including one or more instructions that are stored in a storage medium (e.g., internal memory 1436 or external memory 1438) that is readable by a machine (e.g., the electronic device 1401). For example, a processor (e.g., the processor 1420) of the machine (e.g., the electronic device 1401) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling an electronic device, the method comprising:
obtaining at least one image frame and depth information associated with an augmented reality (AR) scene provided through the electronic device;
determining one or more reflective surfaces in the AR scene, based on the obtained at least one image and the depth information;
identifying a type of the determined one or more reflective surfaces in the AR scene;
generating a reflection map for the one or more reflective surfaces based on a placement of the virtual object, and the identified type of the one or more reflective surfaces, and
applying the generated reflection map on the one or more reflective surfaces to render reflection for the virtual object through the electronic device.

2. The method of claim 1, wherein the obtaining of the at least one image frame and the depth information comprises:
forming a 3-dimensional (3D) mesh for a plurality of 3D points provided in the AR scene based on the at least one image frame and the depth information of the AR scene, and
extracting a plurality of noisy 3D points with missing depth in the formed 3D mesh.

3. The method of claim 2, further comprising:
locating a plurality of 2-dimensional (2D) points associated with the plurality of 3D points on the at least one image frame, and
generating a feature map based on the plurality of 2D points.

4. The method of claim 3, wherein the determining of the one or more reflective surfaces in the AR scene comprises:
analyzing the feature map and the at least one image frame by a feature descriptor operation to generate a plurality of 2D points associated with the one or more reflective surfaces;
re-projecting the generated plurality of 2D points in a plurality of 3D points associated with the one or more reflective surfaces by a reflective surface map generator; and
grouping the plurality of 3D points to provide the one or more reflective surfaces.

5. The method of claim 1, further comprises detecting the placement of the virtual object in the AR scene provided through the electronic device after the at least one image frame and the depth information are obtained.

6. The method of claim 1, wherein the identifying of the type of the one or more reflective surfaces comprises analyzing the at least one image frame and the one or more reflective surfaces by identifying the type of the one or more reflective surfaces from a plurality of predetermined types of the one or more reflective surfaces.

7. The method of claim 6, wherein the plurality of predetermined types includes at least one of a mirror type, a metallic type, a matte type, or a glossy type.

8. The method of claim 1,
wherein the generating of the reflection map comprises generating the reflection map by a reflective ray tracer operation using at least one parameter,
wherein the at least one parameter comprises at least one of a semantic cue, a depth cue, or material cue,
wherein the semantic cue is provided from the one or more reflective surfaces,
wherein the depth cue is provided from the depth information associated with the AR scene, and
wherein the material cue is provided from the identified type of the one or more reflective surfaces.

9. The method of claim 8, further comprising:
analyzing the one or more reflective surfaces, the identified type, and the obtained depth information of the AR scene;
estimating a surface normal to the one or more reflective surfaces based on the analyzed one or more reflective surfaces, the type, and the depth information;
estimating a viewing frustum associated with the obtained depth information based on a viewing angle of the AR scene and a position of the one or more reflective surfaces; and
generating the reflection map for the one or more reflective surfaces based on the estimated viewing frustum,
wherein the reflection map includes a reflective surface rendering color.

10. The method of claim 9, further comprising:
updating the reflection map based on the viewing frustum of the AR scene from the electronic device.

11. The method of claim 10, further comprising:
projecting a ray by the one or more reflective surfaces based on the surface normal and a direction of viewing of the AR scene for each pixel of the one or more reflective surfaces;
determining an intersection of the projected ray with the virtual object to estimate a color, from the reflective surface rendering color, corresponding to a blending mask;
attenuating the estimated color based on one or more material properties of the virtual object; and
applying the reflection map by matting the attenuated estimated color using the reflective surface rendering map, and the reflective surface rendering color on a real frame of the AR scene.

12. The method of claim 1, wherein the rendering of the reflection for the virtual object comprises:
placing the virtual object in an estimated viewing frustum of the one or more reflective surfaces; and
updating the one or more reflective surfaces by a reflective ray tracer operation by rendering the reflection for the virtual object.

13. An electronic device, comprising:
memory, comprising one or more storage media, storing instructions; and
at least one processor communicatively coupled with the memory,
wherein the instructions, when executed by the at least one processor individually or collectively, cause the electronic device to:
obtain at least one image frame and a depth information associated with an augmented reality (AR) scene provided through the electronic device for a user,
determine one or more reflective surfaces in the AR scene, based on the at least one image frame and the depth information,
identify a type of the one or more reflective surfaces in the AR scene,
generate a reflection map for the one or more reflective surfaces based on a placement of the virtual object, and the identified type of the one or more reflective surfaces, and
apply the generated reflection map on the one or more reflective surfaces to render reflection of the virtual object through the electronic device.

14. The electronic device of claim 13, wherein, to obtain the at least one image frame and the depth information, the instructions, when executed by the at least one processor individually or collectively, further cause the electronic device to:
form a 3-dimensional (3D) mesh for a plurality of 3D points provided through the AR scene based on the at least one image frame and the depth information of the AR scene; and
extract a plurality of noisy 3D points with missing depth in the formed 3D mesh.

15. The electronic device of claim 14, wherein the instructions, when executed by the at least one processor individually or collectively, further cause the electronic device to:
locate a plurality of 2-dimensional (2D) points associated with the plurality of 3D points on the at least one image frame; and
generate a feature map based on the located plurality of 2D points.

16. The electronic device of claim 15, wherein, to determine the one or more reflective surfaces in the AR scene, the instructions, when executed by the at least one processor individually or collectively, further cause the electronic device to:
analyze the generated feature map and the at least one image frame by a feature descriptor operation to generate a plurality of 2D points associated with the one or more reflective surfaces;
re-project the plurality of 2D points in a plurality of 3D points associated with the one or more reflective surfaces by a reflective surface map generator; and
group the plurality of 3D points to provide the one or more reflective surfaces.

17. The electronic device of claim 13, wherein, after the at least one image frame and the depth information are obtained, the instructions, when executed by the at least one processor individually or collectively, further cause the electronic device to:
detect the placement of the virtual object in the AR scene provided through the electronic device.

18. The electronic device of claim 13, wherein, to identify the type of the determined one or more reflective surfaces, the instructions, when executed by the at least one processor individually or collectively, further cause the electronic device to:
analyze the at least one image frame and the one or more reflective surfaces by identifying the type of the one or more reflective surfaces from a plurality of predetermined types of the one or more reflective surfaces.

19. The electronic device of claim 18, wherein the plurality of predetermined types includes at least one of a mirror type, a metallic type, a matte type, or a glossy type.

20. The electronic device of claim 13,
wherein, to generate the reflection map, the instructions, when executed by the at least one processor individually or collectively, further cause the electronic device to:
generate the reflection map by a reflective ray tracer operation by using at least one parameter,
wherein the at least one parameter comprises at least one of a semantic cue, a depth cue, or material cue,
wherein the semantic cue is provided from the one or more reflective surfaces,
wherein the depth cue is provided from the depth information associated with the AR scene, and
wherein the material cue is provided from the identified type of the one or more reflective surfaces.
